(19) United States
(12) Patent Application Publication
(10) Pub. No.: US 2017/0271732 A1
(43) Pub. Date: Sep. 21, 2017

(54) STRIPLINE MANIFOLD FILTER ASSEMBLY

(71) Applicant: Amphenol Antenna Solutions, Inc., Rockford, IL (US)

(72) Inventor: CHRISTOPHER W. ROSSITER, Hickory, NC (US)

(21) Appl. No.: 15/234,544

(22) Filed: Aug. 11, 2016

Related U.S. Application Data
(60) Provisional application No. 62/310,249, filed on Mar. 18, 2016.

(51) Int. Cl. H01P 1/203; H01P 7/04; H01P 3/08

(52) U.S. Cl. CPC H01P 1/203; H01P 3/08; H01P 7/04

(57) ABSTRACT

A stripline manifold filter assembly for an antenna includes a stripline manifold bandpass filter. The stripline manifold bandpass filter includes coupled lengths of transmission lines that form coaxial resonators and couplings. The stripline manifold bandpass filter includes coupling bars attached to adjacent coaxial resonators as well as inductive bars attached to coaxial resonators to provide the necessary coupling and resonant frequency requirements to achieve the desired filter response.

### RELATED APPLICATIONS

The present application claims the benefit of U.S. Provisional Application No. 62/310,249, filed Mar. 18, 2016, the entire contents of which are incorporated herein by reference.

### FIELD OF THE INVENTION

The invention relates to bandpass filters and, more specifically, to a stripline manifold assembly that includes a stripline manifold bandpass filter for an integrated antenna diplexer.

### BACKGROUND OF THE INVENTION

The need to integrate more components, for example Radio Frequency (RF) cavity filters such as bandpass filters into an Antenna module in order to reduce Antenna weight is an advantage in the telecommunications industry. To address these needs, bandpass filters using transmission lines such as, for example, striplines, microstrips or coaxial components are used for newer antenna modules with custom designs rather than traditional large commercially available components that are costly, take up too much volume within an available antenna space and increase the overall antenna weight. However, these newer modules take up a larger volume of an antenna space, which increases the weight of the antenna. A module that can reduce the volume of a bandpass filter and which may be tunable to maintain a desired filter response for maximizing antenna efficiency may be beneficial to the art.

### SUMMARY OF THE INVENTION

In accordance with an embodiment of the invention, a stripline manifold filter assembly for an antenna is provided that includes a stripline manifold bandpass filter. The stripline manifold filter assembly may include at least two bandpass filters that can be used for bandpass filtering of an RF signal in an antenna. In an embodiment, the stripline manifold filter assembly includes resonant sections that may share a common ground using inductive line lengths and a reduced number of coupling/grounding screws. A height of the stripline manifold assembly may be reduced by using “air” stripline manifold that may provide a high impedance section (i.e., stripline thickness relative to thickness of housing). In an embodiment, the stripline manifold filter may use capacitive loaded coaxial resonant tophats that provide an additional stepped impedance to tune the resonant frequency of the bandpass filter, which may also reduce the filter height of stripline manifold bandpass filter. In another embodiment, first and last loaded resonant sections of the stripline manifold bandpass filter may be reduced in height by using additional inductive line length with coupling bars between resonant sections. These resonant sections may be grounded using coupling screws that may share one common grounding point between the two adjacent resonant sections. Additionally, the effects of Passive Intermodulation (PIM) are also mitigated with having less mechanical fixing locations compared to conventional cavity filter grounding methods that can create potentially high current discontinuity paths to ground.

### BRIEF DESCRIPTION OF THE FIGURES

FIG. 1 is a general block diagram of a bandpass filter in accordance with an embodiment of the invention;

FIG. 2 is a general block diagram of a diplexer for an antenna module in accordance with an embodiment of the invention;

FIG. 3A is a top view of a stripline manifold filter assembly integrated with a bandpass filter in accordance with the prior art;

FIG. 3B illustrates a circuit topology of a stripline manifold bandpass filter of the stripline manifold filter assembly of FIG. 3A in accordance with the prior art;

FIG. 4A is a perspective sectional view of an implementation of a stripline manifold filter assembly integrated with a stripline manifold bandpass filter in accordance with an embodiment of the invention;

FIG. 4B is a top view of the stripline manifold bandpass filter assembly of FIG. 4A in accordance with an embodiment of the invention;

FIG. 4C is a top view of a stripline manifold bandpass filter used in the stripline manifold bandpass filter assembly of FIGS. 4A-4B in accordance with an embodiment of the invention;

FIG. 4D is a top view of a stripline manifold bandpass filter of FIGS. 4A-4B which is shown with a reduced number of grounding screws in accordance with an embodiment of the invention;

FIG. 4E is a top view of the stripline manifold bandpass filter assembly of FIGS. 4A-4B in accordance with an embodiment of the invention;

FIG. 5 illustrates a model circuit diagram for the bandpass filter of FIGS. 4A-4E in accordance with an embodiment of the invention;

### DETAILED DESCRIPTION OF THE INVENTION

In describing embodiments of the invention illustrated herein and in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes, it being understood that the invention may be embodied in other forms not specifically shown in the drawings.

In accordance with an embodiment of the invention, a stripline manifold filter assembly for an antenna is provided that includes a stripline manifold bandpass filter. In an embodiment, the stripline manifold filter assembly includes coaxial resonator segments that may be selectively tuned using tuning screws. Coupling bars provide an inductive length of transmission line between immediately adjacent coaxial resonator segments. A reduced number of grounding screws may be coupled to the coaxial resonator segments that may share a common ground between the coaxial resonator segments. In an embodiment, the stripline manifold filter may use capacitive loaded coaxial resonant tophats that provide an additional stepped impedance to tune the resonant frequency of the bandpass filter, which may also reduce the filter height of stripline manifold bandpass filter. In another embodiment, first and last loaded resonant sections of the stripline manifold bandpass filter may be reduced in height by using additional inductive line length with coupling bars between resonant sections.

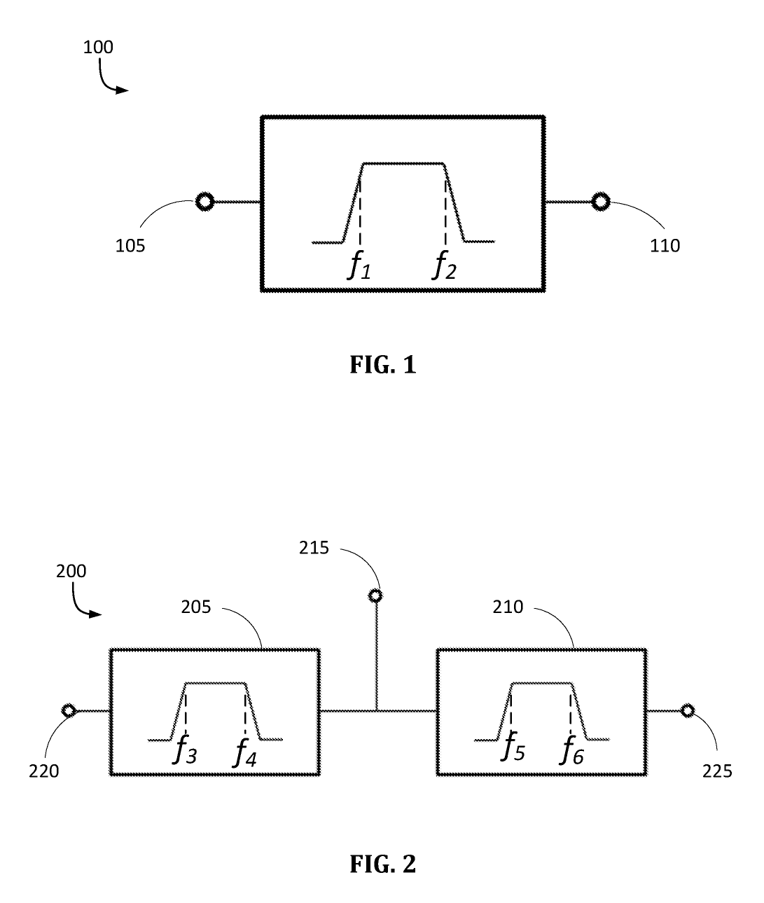

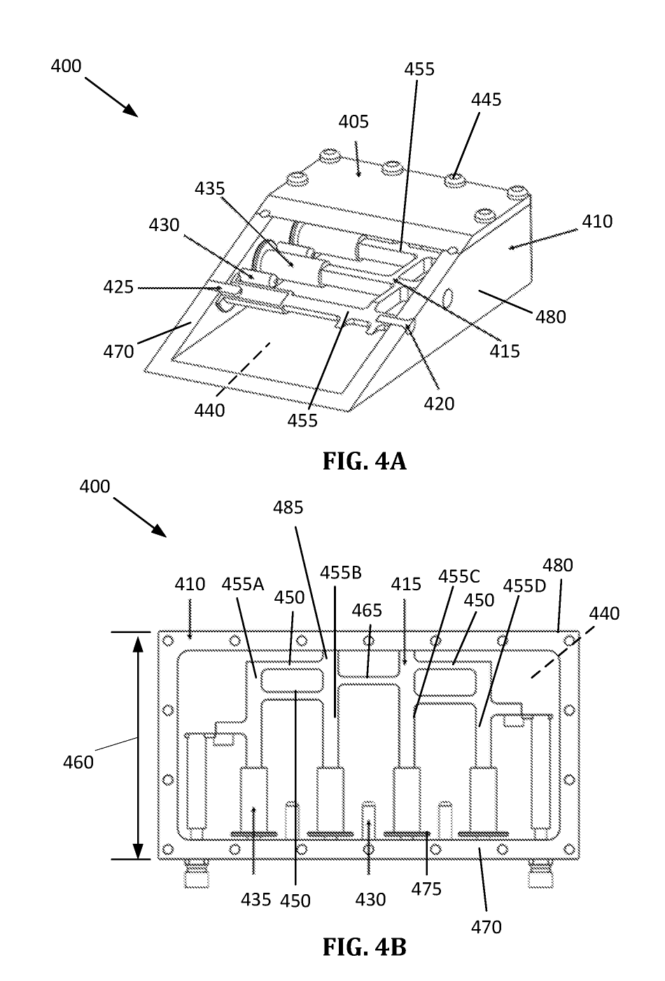

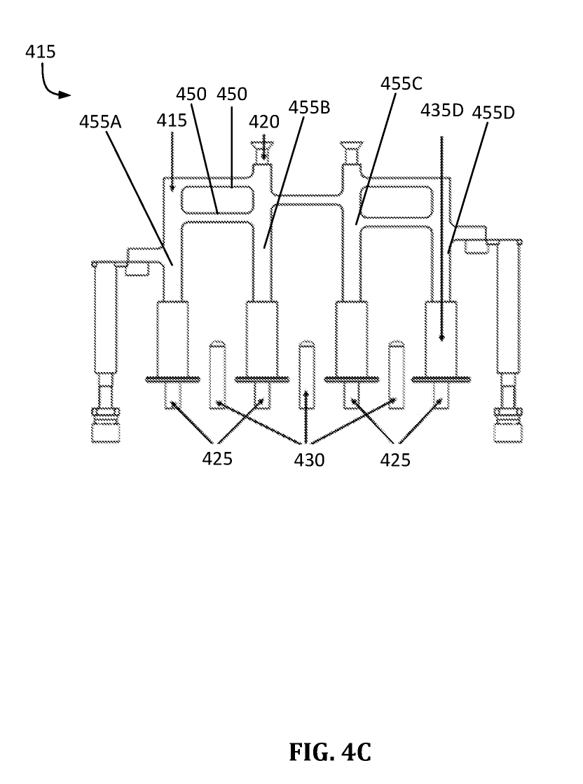

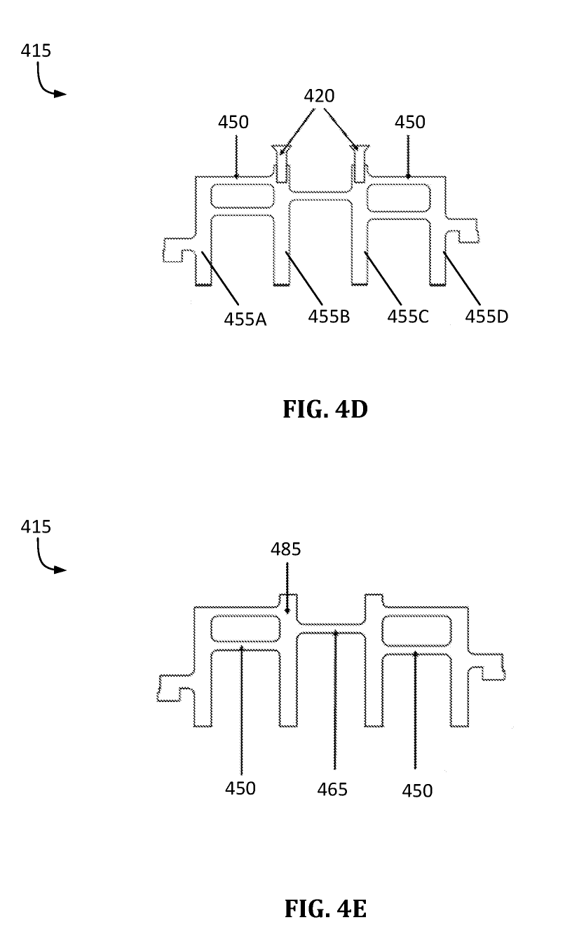

Referring to the figures, FIG. 1 illustrates a block diagram of a bandpass filter, generally designated as 100, that may be used in an antenna module of the present invention, in accordance with an embodiment of the invention. The bandpass filter 100 may be configured to operate within cutoff frequencies expressed in hertz (Hz), kilohertz (kHz), megahertz (MHz), or gigahertz (GHz), called the filter bandwidth. The bandpass filter 100 may include a signal input port 105 and a signal output port 110. The bandpass filter 100 may be configured to receive and/or transmit RF signals in specific frequency ranges at input and output signal ports. In a receive mode, RF signals may be received at signal port 105 and filtered within bandpass filter 100 to allow RF signals, within cutoff frequencies, f₁ and f₂, to pass through to signal port 110. In a transmit mode, operation of ports 105, 110 may be reversed. The range of frequency between f₁ and f₂ is called the filter bandwidth. Signals within a bandwidth of the bandpass filter 100 may pass through the bandpass filter 100 while signals outside the bandwidth are attenuated. In an embodiment, the bandpass filter 100 may be configured as a stripline transmission line with distributed elements of capacitances, resistances and inductances along a length of the transmission line that may be tunable using resonant tuning screws, as will be shown and described below in FIGS. 4A-4E.

FIG. 2 illustrates a block diagram of an integrated RF diplexer 200 that may be used within an integrated antenna module in accordance with an embodiment of the invention. The diplexer 200 may include two bandpass filters 205, 210 that may be implemented as a stripline manifold, in an embodiment. The diplexer 200 may include two bandpass filters 205, 210 configured as two channels, with each bandpass filter 205, 210 being substantially similar to bandpass filter 100. The diplexer 200 may include a common RF signal port 215 and two separate RF transmit/receive signal ports 220, 225. In an embodiment, diplexer 200 may be fixed tuned or tunable over a range of transmit/receive frequencies by tuning one or more resonators to a desired resonant frequency within each bandpass filter 205, 210. A resonant frequency of each bandpass filter 205, 210 is the frequency where the capacitive and inductive reactance of each bandpass filter 205, 210 cancel each other out. The diplexer 200 may be used with an antenna module (not shown) to transmit or receive signals.

Each bandpass filter 205, 210 may be configured to receive and/or transmit RF signals in specific frequency ranges. For example, in a receive mode, bandpass filter 205 may be configured to receive RF signals at signal port 215 and allow signals within cutoff frequencies, f₃ and f₄, to pass through to signal port 220. Bandpass filter 210 may be configured to receive RF signals at signal port 215 and allow signals within cutoff frequencies, f₅ and f₆, to pass through to signal port 225. Each bandpass filter 205, 210 may be tuned based on the frequency that filter bandpass is to be operated. In a non-limiting example, during reception of wireless transmissions, an RF signal may be received at signal port 215 and can selectively propagate through one of the bandpass filters 205, 210 to either signal port 220 or signal port 225 based on the bandwidth of the bandpass filter 205, 210. The bandpass filter 205, 210, may be tuned to a lower or higher frequency, and may produce a very high impedance and hence the transmit signal passes from signal port 215 to signal ports 220, 225 where it may see an impedance as a load.

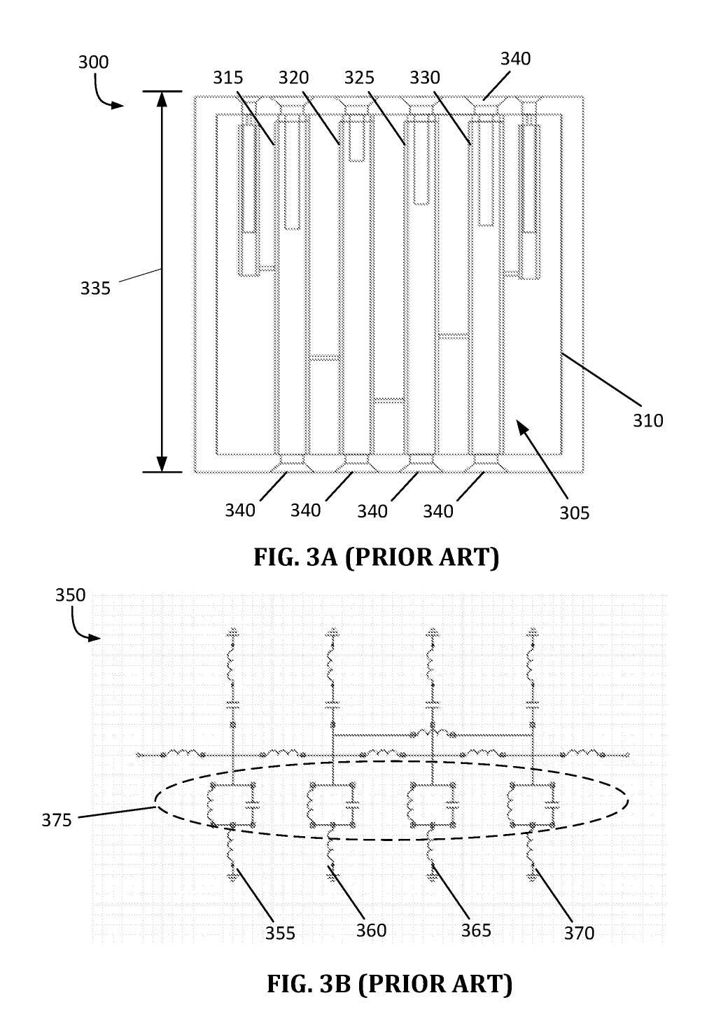

FIG. 3A illustrates a prior art stripline manifold filter assembly 300 integrated with a bandpass filter. Stripline manifold assembly 300 include an “air” stripline manifold bandpass filter 305 contained within enclosure 310. As used herein, an “air” stripline manifold can refer to a conductor suspended in an air dielectric between ground planes. Stripline manifold bandpass filter 305 may be configured as a bandpass filter having single impedance coaxial resonator segments 315, 320, 325 and 330. Each coaxial resonator segment 315-330 is a standard round rod coaxial resonator that has an impedance optimized to provide a desired filter response. However, due to the single impedance of each coaxial resonator segment 315-330, the height of the coaxial resonator segment 315-330 is generally longer in length than the coaxial resonator segments of the present invention. For example, each coaxial resonator segment 315-330 of stripline manifold bandpass filter 305 has a height that is selected to achieve a filter response that cannot be tuned. This results in a stripline manifold filter assembly 300 having length 335 which takes a larger volume in the available antenna space and increases the overall antenna height. In one example, length 335 is at least 100 millimeter (mm) or greater, which is larger than length of the stripline manifold filter assembly 400 of the present invention depicted in FIGS. 4A-4E. Stripline manifold filter 305 may include individual coupling screws 340 that are coupled to each coaxial resonator segment 315-330 at both ends of the coaxial resonator segment 315-330. Each coupling screw 340 provides an RF ground and a mechanical ground, with housing 310, as shown in the circuit topology 350 of FIG. 3B.

As shown in FIG. 3B, circuit topology 350 for stripline manifold bandpass filter 305 illustrates individual ground connections 355, 360, 365, 370 for inductor-capacitor (L-C) impedance elements 375 of each resonator segment 315-330 (FIG. 3A). Ground connections are made using coupling screws 340 (FIG. 3A) that may add additional impedance to ground. Using individual ground connections through coupling screws 340 increases the weight of the stripline manifold filter assembly 300 and overall antenna weight.

FIGS. 4A-4E illustrate an implementation of a stripline manifold filter assembly 400 integrated with a stripline manifold bandpass filter 415 in accordance with an embodiment of the invention. In the illustrated embodiment, a sectional view of stripline manifold assembly 400 illustrates the internal features of bandpass filter 415 including illustrating inner details of a section of coaxial resonant tophat 435 and coaxial resonator segment 455.

As shown in FIGS. 4A-4C, stripline manifold assembly 400 may include an “air” stripline manifold bandpass filter 415 and housing 410. Stripline manifold bandpass filter 415 may include at least two bandpass filters that are configured as stripline transmission lines of varying cross-sections and lengths that define inductances and capacitances for the bandpass filter. In one non-limiting example, the cross-sectional area of the transmission lines may be greater than prior art bandpass filters and can have a high impedance section as defined by stripline thickness relative to enclosure/housing 410 thickness. The housing 410 should be thick enough to provide adequate mounting support, for instance a minimum of 4 mm. In an embodiment, stripline manifold bandpass filter 415 is an air cavity filter that includes transmission lines in a manifold and suspended in cavity 440 within housing/enclosure 410. The stripline manifold bandpass filter 415 may be coupled to sidewalls of the housing 410 with coupling/grounding screws 420. The coupling/grounding screws 420 may be inserted into one end of the coaxial resonator segment 455 proximal to one wall 480 of housing 410. Housing 410 may function as an RF ground and mechanical support for stripline manifold bandpass filter 415. Housing 410 is generally rectangular in shape and includes a conductive enclosure with a conductive cover 405 that enclose cavity 440. Cover 405 (FIG. 4A) may be selectively coupled to housing 410 with screws 445 (FIG. 4A) to enclose the stripline manifold bandpass filter 415. Other connectors in lieu of screws are also contemplated for use in stripline manifold assembly 400.

Also illustrated in FIGS. 4A-4C, stripline manifold bandpass filter 415 may include coupling screws 420, resonant tuning screws 425, coupling segments 450 (FIGS. 4B-4C), resonator segments 455A-455D (FIG. 4B-4C) (i.e., planar conductive portions) and coaxial resonant tophat 435. Each resonator segment 455A-455D may have a square cross-section that is coupled to a circular cross-sectioned resonant tophat 435. The coupling segments 450 may be used to provide the desired filter impedances or couplings in the bandpass filter embodied in stripline manifold bandpass filter 415. For example, the coupling segments 450 may provide a length of inductive impedance between adjacent resonator segments 455A-455D (FIG. 4B-4C) or any other impedances, for example, a 50 ohm impedance or other impedance. FIG. 4B shows two couplings 450 that extend between adjacent resonator segments 455A, 455B to provide the desired impedance between resonator segments 455A-455B. Two couplings 450 may also be used between adjacent resonator segments 455C, 455D for a desired impedance. And, the couplings 450 may be substantially perpendicular to the resonator segments 455A, 455B and couple the resonator segments 455A, 455B together. Further the coupling 465, which may be similar to coupling 450, may be used to provide an impedance, for example, an inductive length of line and couple adjacent resonator segments 455B, 455C.

Though two couplings 450 are shown between segments 455A and 455B, and between 455C and 455D, and a single coupling 465 is shown between segments 455B and 455C, any number of couplings can be utilized, including one or more. And any number of couplings substantially similar to couplings 450, 465, may be used between resonator segments 455A-455D to provide the desired impedance connections for stripline manifold bandpass filter 415. As shown, the couplings between 455A, 455B are aligned with the couplings between 455C and 455D and offset from the coupling 465. However, any suitable arrangement can be provided, for example the couplings 450, 465 can all be aligned with one another and/or offset from each other.

Coaxial resonant tophat 435 of each resonator segment 455A-455D is generally cylindrical in shape and terminates into a circular flange 475. In one non-limiting example, coaxial resonant tophat 435 may be integrally formed with resonator segment 455A-455D. However, in another example, coaxial resonant tophat 435 may initially be separately formed and later connected to resonator segment 455A-455D. Resonant tophats 435 are coupled to resonator segments 455A-455D and include a cavity that may be accessed along wall 470. The resonant tophats 435 can be integrally formed (e.g., casted) with the resonator segment 455 or can be individually fastened via mechanical fixing screws or soldered to the resonator segments 455. The resonant tophats 435 are located along one wall of the housing 410 to provide additional capacitance (controlled by the circular flange 475 diameter) to achieve lower frequency for fixed amount of tuning screw thus lowering the overall height of the filter 415. The resonant tophat 435 may have a larger outer diameter section than a diameter of resonator segment 455A-455D (e.g., larger diameter than a diameter/width of resonator segment 455A-455D that is directionally opposite to coaxial resonant tophat 435). The coaxial resonant tophat 435 includes an inner longitudinal cavity that the flange 475 that may be coupled to an inner surface of the wall 470 to provide mechanical support for the coaxial resonant tophat and as an RF ground.

Each coaxial resonant tophat 435 may provide a stepped impedance resonator where the impedance (capacitive impedance) may be tuned (i.e., changed) by varying degrees (i.e., as stepped impedances) with the resonant tuning screw 425. The stepped impedance relates to each individual tophat 435. Different geometry tophats 435 can be provided at each location, thus having varying stepped impedance tophats 435. A stepped impedance reduces the overall height of the tophat 435 and reduces the variable tuning capacitance required as a larger fixed capacitance is achieved from the diameter of the tophat. Coaxial resonant tophat 435 may be tuned by using the tuning screw 425 that can be selectively inserted or retracted into the longitudinal cavity of the coaxial resonant tophat 435. For example, inserting tuning screw 425 into the inner longitudinal cavity of coaxial resonant tophat 435 decreases the resonant frequency due to an increase in capacitance of resonator segment 455. Retracting tuning screw 425 from the inner longitudinal cavity of coaxial resonant tophat 435 from an inserted position increases the resonant frequency due to a decrease in capacitance of resonator segment 455A-455D. Resonant tuning screws 425 may also provide mechanical support of the coaxial resonant tophats 435 (FIG. 4B-4C) of the resonator segments 455. Coupling bars 430 may be configured to be selectively inserted or retracted into cavity 440 to obtain the desired bandpass filter couplings between resonator segments 455A-455D (FIG. 4B-4C). Coupling bars 430 may be inserted into a hole formed along one wall 470 of housing 410 between resonant tophats 435 and may extend parallel to resonant tophats 435. The tophats 435 should be positioned along the centerline and in line with resonator segments 455 since any offset will reduce the amount of coupling and require more coupling bar 430 penetration into the cavity 440 to achieve desired coupling. Thus, as shown, the tophats 435 are each arranged linearly with a respective resonator segment 455, and each tophat 435 and respective resonator segment 455 are parallel to one another. In addition, the coupling segments 450 are substantially perpendicular to the resonator segments 455, and the tophats 435, segments 450, 455, are in a single plane.

The stepped impedance of the coaxial resonant elements 455 may provide the benefit of reducing overall length of the stripline manifold assembly 400 over the prior art stripline manifold assembly 300 (FIG. 3). In one non-limiting example, the length 460 may be approximately 65 mm. The benefits of stripline manifold bandpass filter 415 include impedance stepping using multiple number of stepped impedance resonator segments 455A-455D, which reduces the overall length of the stripline manifold filter assembly 400 over the prior art. As mentioned for instance, the stepped impedance reduces the overall height of the tophat 435 and reduces the variable tuning capacitance required as a larger fixed capacitance is achieved from the diameter of the tophat 435. Further benefits include mitigating or reducing the potential for PIM by using a reduced number of coupling screws 420. Coupling screws 420, which may be substantially similar to tuning screw 425, may be coupled to resonator segments 455B-455C (FIG. 4C) and provide mechanical support and RF grounding of stripline manifold filter 415.

The stripline manifold filter assembly 400 may be used to overcome the limitations of conventional stripline manifold filter assemblies. For example, the height of stripline manifold assembly 400 may be reduced by using “air” stripline manifold that may provide a high impedance section (i.e., stripline thickness relative to thickness of housing 410). Additionally, filter length in the stripline manifold bandpass filter 415 may be reduced by using capacitive loaded coaxial resonant tophats 435 that provide an additional stepped impedance. Further, the first and last loaded resonant sections 455A-455B and 455C-455D can be reduced in height by using additional inductive line lengths with coupling segments 450 between resonant sections 455A-455B and 455C-455D. These resonant sections 455A-455B and 455C-455D may be grounded using coupling screws 420 that share one common grounding point between the two adjacent resonant sections 455A-455B and 455C-455D. The common grounding point 485 may mitigate the effects of Passive Intermodulation (PIM) with having less mechanical fixing locations with two coupling screws 420 as compared to conventional cavity filter grounding methods that have grounding screws on each resonant section. These additional screws can create potentially high current discontinuity paths to ground due to higher likelihood of failure in the mechanical joints. In one example embodiment, a 35% reduction in height is achieved for the filter design using the high impedance stripline section in conjunction with the stepped impedance resonant tophat. However, the height and length can vary depending on the desired application, and other suitable height and length can be provided within the spirit and scope of the invention.

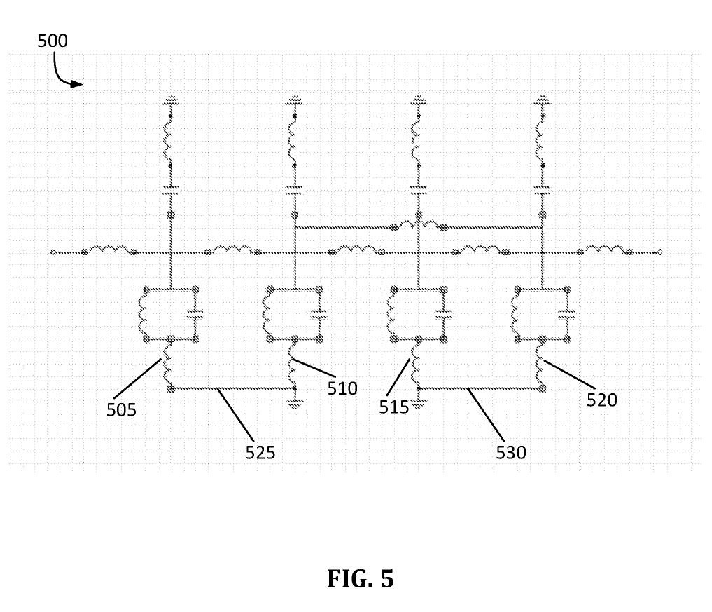

As shown in FIGS. 4D-4E, an implementation of a stripline manifold filter 415 illustrate resonator segments 455A-455D that include couplings 450, 465 and coupling screws 420. Specifically, FIG. 4D illustrates a stripline manifold bandpass filter 415 with a reduced number of coupling screws 420 that may be used for mechanical support and RF grounding of stripline manifold bandpass filter 415 to housing 410 (shown in FIG. 4A). In one non-limiting example, stripline manifold bandpass filter 415 may integrate ends 485 of resonator segments 455A-455D to a mechanical fixing point on an adjacent resonator segments such as, adjacent segments 455A-455B and adjacent segments 455C-455D by using coupling segments 450 to achieve the desired filter impedances. Coupling segments 450 may define a length of impedance, for example, an inductance for manifold bandpass filter 415. Coupled resonator segments 455A-455B may be mechanically grounded through coupling screw 420 while coupled resonator segments 455C-455D may be mechanically grounded through coupling screw 420. The coupled segments 455A-455B and 455C-455D have a common shared grounding point, shown in FIG. 5, which reduces the quantity of coupling screws 420 from four screws in the prior art to two screws in the present invention and hence the weight of in the stripline manifold filter assembly. On the other hand segments 455B and 455C are separated via an inductive length coupling 465 to achieve a desired filter response.

FIG. 5 illustrates a model circuit topology 500 for a stripline manifold bandpass filter 415 in accordance with an embodiment of the invention. With continued reference to FIGS. 4D-4E, model circuit diagram 500 of a bandpass filter may be embodied in stripline manifold bandpass filter 415 and uses a reduced number of coupling screws 420 to couple the resonator segments 455A-455D to a housing, for example housing 410 of FIG. 4A to provide mechanical support and RF grounding. The model topology 5600 includes distributed inductive and distributed capacitive elements that are distributed along the lengths of the conductive transmission lines of stripline manifold bandpass filter 415. The use of two coupling screws 420 provides benefits and advantages over the prior art stripline manifold bandpass filter of FIG. 3. Inductive elements 505, 510 of adjacent resonator segments 455C-455D may be shunted/coupled to each other using common shared grounding 525 through coupling screw 420 while inductive elements 515, 520 of adjacent resonator segments 455A-455B may be shunted/coupled to each other using shared grounding 530 through coupling screw 420. The shared grounding 525 or 530 made through a reduced number of coupling/grounding screws 420 and stepped impedance that can be tuned using coaxial resonant tophats 435 (FIG. 4B) reduces weight and volume of the stripline manifold filter assembly 415.

The following examples pertain to further embodiments:

Example 1 is a filter assembly, comprising a housing enclosing a cavity; a manifold bandpass filter coupled to the housing and residing within the cavity, the manifold filter including a plurality of resonator segments, each resonator segment of the plurality of resonator segments having a respective longitudinal cavity extending at least partially into the coaxial resonator; coupling segments coupled to one or more coaxial resonators of the plurality of coaxial resonators; and a plurality of resonant tuning screws, each resonant tuning screw of the plurality of resonant tuning screws received in the longitudinal cavity of a respective coaxial resonator of the plurality of coaxial resonators.

In Example 2, the circuit of Example 1 can include, a cover coupled to the housing, the cover configured to enclose the manifold bandpass filter inside the cavity.

In Example 3, the circuit of Example 1 or 2 can include, wherein the manifold bandpass filter includes at least two output filters arranged as bandpass filters.

In Example 4, the circuit of Example 1 to 3 can include, wherein each coupling segment is configured to provide a filter coupling between immediately adjacent coaxial resonators of the plurality of coaxial resonators.

In Example 5, the circuit of Example 1 to 4 can include, wherein at least one coupling segment is configured to provide an inductive impedance between immediately adjacent coaxial resonators of the plurality of coaxial resonators.

In Example 6, the circuit of Example 1 to 5 can include, further comprising coupling bars coupled to the housing, each coupling bar is configured to be selectively inserted into or retracted from the cavity.

In Example 7, the circuit of Example 16 can include, wherein each of the coupling bars is configured to couple two immediately adjacent coaxial resonators of the plurality of coaxial resonators.

In Example 8, the circuit of Example 1 to 7 can include, wherein each of the coaxial resonators includes a resonant tophat impedance section having the longitudinal cavity.

In Example 9, the circuit of Example 8 can include, wherein each of the resonant tuning screws is configured to be selectively inserted into the longitudinal cavity of the resonant tophat impedance section or to be selectively retracted from the longitudinal cavity of the resonant tophat impedance section.

In Example 10, the circuit of Example 9 can include, wherein each of the resonant tuning screws is configured to change an impedance of the resonant tophat impedance section when inserted into the longitudinal cavity.

In Example 11, the circuit of Example 1 to 10 can include, further comprising a plurality of grounding screws, each grounding screw configured to mechanically ground the manifold bandpass filter to the housing.

In Example 12, the circuit of Example 11 can include, wherein each of the grounding screws is configured to be coupled to adjacent coaxial resonators and provide a common ground between the adjacent coaxial resonators.

Example 13 is a manifold bandpass filter, comprising a plurality of resonator segments, each resonator segment of the plurality of resonator segments having a respective longitudinal cavity extending at least partially into the coaxial resonator; coupling segments coupled to one or more coaxial resonators of the plurality of coaxial resonators; and a plurality of resonant tuning screws, each resonant tuning screw of the plurality of resonant tuning screws received in the longitudinal cavity of a respective coaxial resonator of the plurality of coaxial resonators.

In Example 14, the circuit of Example 13 can include, wherein the manifold bandpass filter includes at least two output filters arranged as bandpass filters.

In Example 15, the circuit of Example 13 to 14 can include, wherein each coupling segment is configured to provide a filter coupling between immediately adjacent coaxial resonators of the plurality of coaxial resonators.

In Example 16, the circuit of Example 13 to 15 can include, wherein each of the coupling segments is configured to provide an inductive impedance between immediately adjacent coaxial resonators of the plurality of coaxial resonators.

In Example 17, the circuit of Example 13 to 16 can include, further comprising a plurality of coupling bars, wherein each coupling bar of the plurality of coupling bars is configured to couple two immediately adjacent coaxial resonators of the plurality of coaxial resonators.

In Example 18, the circuit of Example 13 to 17 can include, wherein each coaxial resonator of the plurality of coaxial resonators includes a resonant tophat impedance section having the longitudinal cavity.

In Example 19, the circuit of Example 13 to 18 can include, wherein each resonant tuning screw of the plurality of resonant tuning screws is configured to be selectively inserted into the longitudinal cavity of the resonant tophat impedance section or to be selectively retracted from the longitudinal cavity of the resonant tophat impedance section.

In Example 20, the circuit of Example 19 can include, wherein each of the resonant tuning screws is configured to change an impedance of the resonant tophat impedance section when inserted into the longitudinal cavity.

In Example 21, the circuit of Example 13 to 20 can include, further comprising a plurality of grounding screws, each grounding screw of the plurality of grounding screws is configured to be coupled to adjacent coaxial resonators and provide a common ground between the adjacent coaxial resonators.

The foregoing description and drawings should be considered as illustrative only of the principles of the invention. The invention may be configured in a variety of shapes and sizes and is not intended to be limited by the embodiments. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A filter assembly, comprising:
a housing enclosing a cavity;
a manifold bandpass filter coupled to the housing and residing within the cavity, the manifold filter including:
a plurality of resonator segments, each resonator segment of the plurality of resonator segments having a respective longitudinal cavity extending at least partially into the coaxial resonator;
coupling segments coupled to one or more coaxial resonators of the plurality of coaxial resonators; and
a plurality of resonant tuning screws, each resonant tuning screw of the plurality of resonant tuning screws received in the longitudinal cavity of a respective coaxial resonator of the plurality of coaxial resonators.

2. The filter assembly of claim 1, further comprising a cover coupled to the housing, the cover configured to enclose the manifold bandpass filter inside the cavity.

3. The filter assembly of claim 1, wherein the manifold bandpass filter includes at least two output filters arranged as bandpass filters.

4. The filter assembly of claim 1, wherein each coupling segment is configured to provide a filter coupling between immediately adjacent coaxial resonators of the plurality of coaxial resonators.

5. The filter assembly of claim 1, wherein at least one coupling segment is configured to provide an inductive impedance between immediately adjacent coaxial resonators of the plurality of coaxial resonators.

6. The filter assembly of claim 1, further comprising coupling bars coupled to the housing, each coupling bar is configured to be selectively inserted into or retracted from the cavity.

7. The filter assembly of claim 6, wherein each of the coupling bars is configured to couple two immediately adjacent coaxial resonators of the plurality of coaxial resonators.

8. The filter assembly of claim 1, wherein each of the coaxial resonators includes a resonant tophat impedance section having the longitudinal cavity.

9. The filter assembly of claim 1, wherein each of the resonant tuning screws is configured to be selectively inserted into the longitudinal cavity of the resonant tophat impedance section or retracted from the longitudinal cavity of the resonant tophat impedance section.

10. The filter assembly of claim 9, wherein each of the resonant tuning screws is configured to change an impedance of the resonant tophat impedance section when inserted into the longitudinal cavity.

11. The filter assembly of claim 1, further comprising a plurality of grounding screws, each grounding screw configured to mechanically ground the manifold bandpass filter to the housing.

12. The filter assembly of claim 11, wherein each of the grounding screws is configured to be coupled to adjacent coaxial resonators and provide a common ground between the adjacent coaxial resonators.

13. A manifold bandpass filter, comprising:
a plurality of resonator segments, each resonator segment of the plurality of resonator segments having a respective longitudinal cavity extending at least partially into the coaxial resonator;
coupling segments coupled to one or more coaxial resonators of the plurality of coaxial resonators; and
a plurality of resonant tuning screws, each resonant tuning screw of the plurality of resonant tuning screws received in the longitudinal cavity of a respective coaxial resonator of the plurality of coaxial resonators.

14. The manifold bandpass filter of claim 13, wherein the manifold bandpass filter includes at least two output filters arranged as bandpass filters.

15. The manifold bandpass filter of claim 13, wherein each coupling segment is configured to provide a filter coupling between immediately adjacent coaxial resonators of the plurality of coaxial resonators.

16. The manifold bandpass filter of claim 13, wherein each of the coupling segments is configured to provide an inductive impedance between immediately adjacent coaxial resonators of the plurality of coaxial resonators.

17. The manifold bandpass filter of claim 13, further comprising a plurality of coupling bars, wherein each coupling bar of the plurality of coupling bars is configured to couple two immediately adjacent coaxial resonators of the plurality of coaxial resonators.

18. The manifold bandpass filter of claim 13, wherein each coaxial resonator of the plurality of coaxial resonators includes a resonant tophat impedance section having the longitudinal cavity.

19. The manifold bandpass filter of claim 13, wherein each resonant tuning screw of the plurality of resonant tuning screws is configured to be selectively inserted into the longitudinal cavity of the resonant tophat impedance section or to be selectively retracted from the longitudinal cavity of the resonant tophat impedance section.

20. The manifold bandpass filter of claim 19, wherein each of the resonant tuning screws is configured to change an impedance of the resonant tophat impedance section when inserted into the longitudinal cavity.

21. The manifold bandpass filter of claim 13, further comprising a plurality of grounding screws, each grounding screw of the plurality of grounding screws is configured to be coupled to adjacent coaxial resonators and provide a common ground between the adjacent coaxial resonators.
